(19) United States
(12) Patent Application Publication
(10) Pub. No.: US 2012/0110815 A1
(43) Pub. Date: May 10, 2012

(54) Rivet Press

(76) Inventor: Jimmy M. Brown, Pearland, TX (US)

(21) Appl. No.: 12/941,479

(22) Filed: Nov. 8, 2010

(51) Int. Cl. B23P 19/00

(52) U.S. Cl. 29/426.5; 29/283.5

(57) ABSTRACT

A device for pressing out rivets from a work piece wherein the device comprises a C shaped frame with two oppositely aligned end. One tool end is fabricated to accept a threaded rod. By turning the threaded rod, the rod end extends toward a second tool end. The second tool end contains an orifice which can accept a hollow bushing. The threaded rod can be fitted with a press pin matching the diameter of the rivet. The threaded rod can be turned with a ratchet wrench or impact wrench.

### BACKGROUND OF INVENTION

1. Field of Use

Rivets are commonly used to attached equipment or components to other equipment or components. Unlike nuts and bolts, there is no easy way to remove rivets. Rivets are destroyed in the removal process.

2. Related Art

Past practice has required rivets to be removed by drilling out the rivet from the attachment hole of the equipment. This is a time consuming and hazardous endeavor. It requires use of a drill bit to consume the rivet material. This generates an abundance of small sharp metal shavings that can be hazardous to workers. Another practice has been to hammer out the rivet from the equipment. This requires force and skill in striking a small diameter object with a heavy hammer.

### SUMMARY OF INVENTION

The present invention uses modern tooling to press a rivet from the hole joining two pieces of equipment. The tool subject of this disclosure utilizes a threaded rod to smoothly and exactly bring force to bear on the rivet. The tool utilizes a curved C shaped frame. Each end of the C shaped frame is modified. The first end is machine threaded to receive a threaded rod. One end of the rod can be machined to accept a socket or impact drive tool. The threaded rod can be rotated, screwing down the rod to press upon one end of the rivet. The second frame end comprises an opening through which the rivet can be ejected. The hole in the second frame end aligns with the threaded rod.

### SUMMARY OF THE DRAWINGS

FIG. 1 is a perspective view of the tool illustrating the C shape of the tool frame and the first and second tool ends, the threaded rod, pin adapter, bushing and orifice in the second tool end.

FIG. 2 is a side view of the tool illustrating the depth of the tool frame to the axis of orientation of the threaded rod and second tool end hole.

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

### DETAILED DESCRIPTION OF DISCLOSURE

The tool subject of this disclosure may be made from steel or other high strength material. It can be made in various sizes and dimensions. It is preferably made such that the distance between the interior back side of the C shaped frame and axis of orientation of the threaded rod and hole at the second frame end is greater than one half the distance between the first and second frame end. Stated differently, the C shape should be full or deep in contrast to shallow or flat. This is advantageous since the tool must be able to fit around or fit over equipment or components that are riveted together. This shape allows the tool to be used to remove rivets that are distant from an equipment edge.

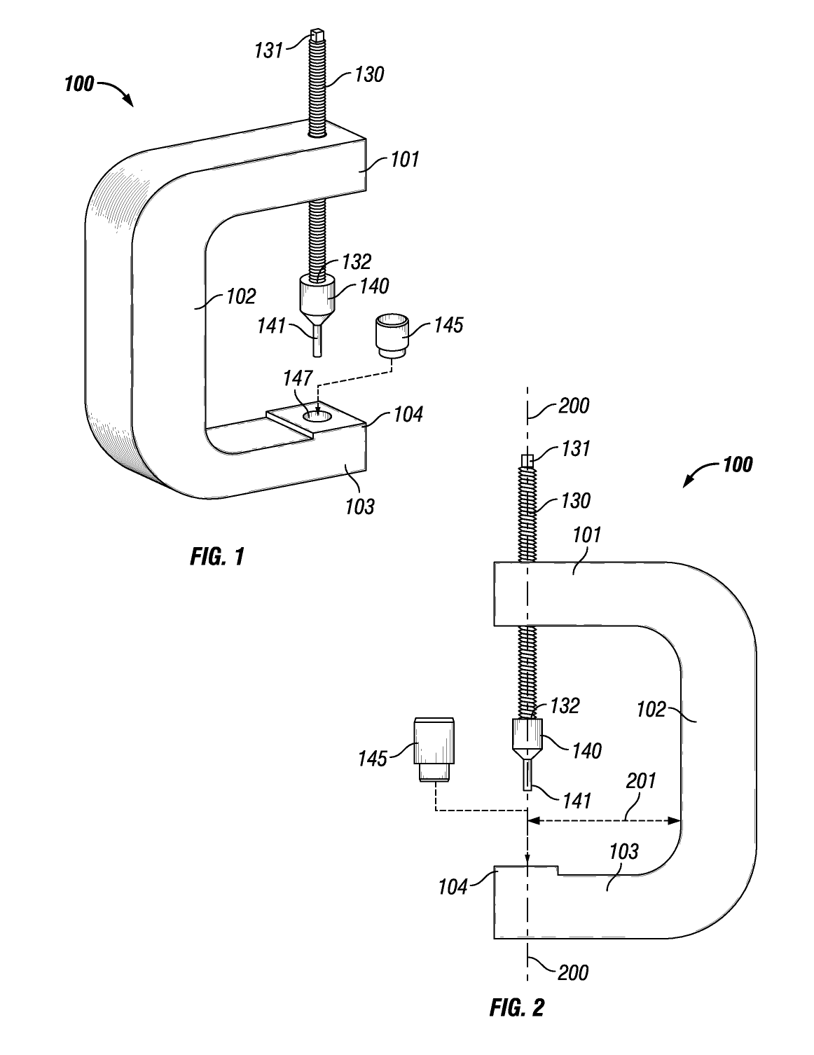

With reference to FIGS. 1 and 2, the tool frame 100 is C shaped. The two ends of the C shape are the first 101 and second 102 ends of the tool. The two ends align opposite each other. The first end of the tool is machined to accept a threaded rod 130. In one embodiment, the threaded rod has a ¾ inch diameter. The thread pattern can be fine, thereby requiring more turns for linear distance traveled. This allows greater pressing force to be used on a rivet.

In one embodiment, the frame is 10 inches long. The frame is 2 inch by 2 inch square. The frame expands to 2½ inches thick at the back side 102 of the C frame. The axis of orientation 200 of the threaded rod 130 and the orifice 147 of the second end is the same. In one embodiment, the space between the first frame end and the second frame end is 6 inches. The distance 201 between the axis of orientation of the threaded rod and the back of the C frame is 3¾ inches. Other dimensions are within the scope of this disclosure.

The threaded rod has a first end 131 and a second end 132. The second end can be fitted with a press pin 140. In one embodiment, the press pin threads over the second end of the threaded rod. The press pin is shaped to accommodate the ¾ inch threaded rod. In another embodiment, the press pin may fit onto the threaded rod utilizing a detent. The press pin tapers to a small diameter surface 141. This small diameter surface is intended to be equal to or smaller than the diameter of the rivet. In one embodiment, the press pin can be fabricated with a ⅜ inch diameter surface, 5/16 inch and ¼ inch diameter surface. Other sizes are within the scope of this disclosure.

The first end 131 of the threaded rod can be machined to fit into a socket wrench or air powered impact wrench. It will be appreciated that the socket wrench or impact wrench supplies the power to drive the threaded rod into the rivet.

The threaded rod 130 (and the threaded hole of the first frame end) has a longitudinal axis of orientation. This axis of orientation 200 is same as the axis of the hole 147 fabricated in the second frame end 103. The second frame end has a hole cut into the end. In one embodiment this hole is 1 inch diameter. The second frame end can have a small raised portion 104 causing the second frame end to be thicker. This can support the stress which is experienced by the second frame end by the pressure of the turning threaded rod pressing the riveted equipment piece (work piece).

In one embodiment, the tool is equipped with a hollow bushing 145 that fits onto the hole 147 in the second frame end. In one embodiment, the bushing may fit onto the hole with a detent. On this bushing, the work piece containing the rivet is placed. The longitudinal axis of the rivet is aligned with the axis of the hole of the second frame end and the threaded rod. In one embodiment, the bushing may be fabricated to provide a surface conforming to the work piece to facilitate the alignment of the rivet with the alignment of the threaded rod (and press pin).

In addition, this specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

1. A tool comprising:
(a) a frame having first end and an opposite positioned second end;
(b) the first end having a threaded first orifice;
(c) the second end having a second orifice wherein the axis of orientation of first orifice and the second orifice are the same; and
(d) a threaded rod extending through the first orifice wherein the first end of the threaded rod is oriented to the second orifice.

2. The tool of claim 1 further comprising a hollow bushing fitting into the second orifice.

3. The tool of claim 2 wherein the hollow bushing fits into the second orifice with a detent.

4. The tool of claim 2 further comprising the threaded rod extendible into the bushing.

5. The tool of claim 1 further comprising a space between the first frame end and the second frame end.

6. The tool of claim 1 further comprising a frame back joining the first frame end and the second frame end.

7. The tool of claim 6 further comprising a relationship between the frame back and the axis of orientation is greater than one half the distance between the first frame end and the second frame end.

8. The tool of claim 1 further comprising a press pin fitably attached to the first end of the threaded rod.

9. The tool of claim 8 wherein the press pin threads on to the first end of the threaded rod.

10. The tool of claim 8 wherein the press pin attaches to the first end of the threaded rod with a detent.

11. The tool of claim 8 further comprising a press pin having a diameter of ⅜ inch, 5/16 inch or ¼ a inch.

12. The tool of claim 1 further comprising the second end of the threaded rod being adapted to fit with a socket wrench or impact wrench.

13. The tool of claim 1 where the frame ends are 2 inches by 2 inches and the frame back is 2½ inches by 2 inches.

14. The tool of claim 1 wherein the threaded rod is ¾ inches in diameter.

15. The tool of claim 1 wherein the orifice of the second frame end is 1 inch in diameter.

16. A method of removing rivets comprising the steps of:
(a) placing the bushing and second frame end orifice over a first rivet end;
(b) threading the threaded rod with press pin against the second rivet end; and
(c) continuing to turn the threaded rod to push the rivet out between the bushing and the press pin.

17. The method of claim 16 further comprising pushing the rivet through the orifice of the bushing and second tool end.
